(19) United States
(12) Patent Application Publication
(10) Pub. No.: US 2016/0372047 A1
(43) Pub. Date: Dec. 22, 2016

(54) ORGANIC LIGHT EMITTING DISPLAY DEVICE AND METHOD OF DRIVING AN ORGANIC LIGHT EMITTING DISPLAY DEVICE

(71) Applicant: SAMSUNG DISPLAY CO., LTD., Yongin-si (KR)

(72) Inventors: Dong Woo Kim, Seongnam-si (KR); Keum Nam Kim, Seoul (KR); Yang Hwa Choi, Yongin-si (KR)

(21) Appl. No.: 14/993,046

(22) Filed: Jan. 11, 2016

(30) Foreign Application Priority Data
Jun. 16, 2015 (KR) 10-2015-0085177

(51) Int. Cl. G09G 3/3266; G09G 3/3258

(52) U.S. Cl. CPC G09G 3/3266; G09G 3/3258; G09G 2310/062; G09G 2310/08; G09G 2310/0283; G09G 2310/0213

(57) ABSTRACT

A method of driving an organic light emitting display device may include concurrently initializing pixels by adjusting a voltage level of a power voltage which is provided to the pixels during an initialization period of a (2k−1)-th image frame, sequentially writing a first data signal including the (2k−1)-th image frame into the pixels by sequentially performing a scanning operation on a plurality of scan lines in a first direction, displaying the (2k−1)-th image frame by sequentially providing an emission signal to emission lines in the first direction, concurrently initializing the pixels during an initialization period of a (2k)-th image frame, sequentially writing a second data signal including the (2k)-th image frame into the pixels by sequentially performing the scanning operation on the scan lines in a second direction, and displaying the (2k)-th image frame by sequentially providing the emission signal to the emission lines in the second direction.

### CROSS REFERENCE TO RELATED APPLICATION

This application claims priority to, and the benefit of, Korean Patent Applications No. 10-2015-0085177, filed on Jun. 16, 2015 in the Korean Intellectual Property Office (KIPO), the disclosure of which is incorporated by reference herein in its entirety.

### BACKGROUND

1. Field

Embodiments of the present invention relate to display devices. More particularly, example embodiments of the present invention relate to display devices configured to employ a concurrent driving technique and a sequential driving technique.

2. Description of the Related Art

A technique for driving a display device may be classified roughly into a sequential emission driving technique and a concurrent emission driving technique (e.g., a simultaneous emission driving technique). Specifically, the sequential emission driving technique sequentially performs a scanning operation for each scan-line, and sequentially controls pixel circuits to emit light for each scan-line (i.e., sequentially performs a light emitting operation). The concurrent emission driving technique sequentially performs the scanning operation for each scan-line, and controls all pixel circuits to concurrently (e.g., simultaneously) emit light (i.e., concurrently performs a light emitting operation).

Generally, in the concurrent emission driving technique, a frame operation period for displaying one image frame may include an initialization period for performing an initializing operation, a reset period for performing a resetting operation, a threshold voltage compensation period for performing a threshold voltage compensating operation, a scan period for performing a scanning operation, and an emission period for performing a light emitting operation. The concurrent emission driving technique performs the initializing operation, the resetting operation, and the compensating operation in sufficient time.

However, because the light emitting operation is performed after the initializing operation, the resetting operation, and the compensating operation are finished, an emission duty takes less than about 50% of one image frame. Accordingly, a large amount of driving current is used for luminance representation, which may result in increased power consumption and decreased life of an organic light emitting diode.

### SUMMARY

Example embodiments provide a method of driving an organic light emitting display device based on a combination of a concurrent driving technique and a sequential driving technique.

Example embodiments provide an organic light emitting display device capable of being driven by a combination of a concurrent driving technique and a sequential driving technique.

According to example embodiments, a method of driving an organic light emitting display device may include concurrently initializing a plurality of pixels by adjusting a voltage level of a power voltage which is provided to the pixels during an initialization period of a (2k−1)-th image frame, where k is a positive integer, sequentially writing a first data signal including the (2k−1)-th image frame into the plurality of pixels by sequentially performing a scanning operation on a plurality of scan lines in a first direction, displaying the (2k−1)-th image frame by sequentially providing an emission signal to a plurality of emission lines in the first direction, concurrently initializing the pixels by adjusting the voltage level of the power voltage during an initialization period of a (2k)-th image frame, sequentially writing a second data signal including the (2k)-th image frame into the plurality of pixels by sequentially performing the scanning operation on the plurality of scan lines in a second direction, and displaying the (2k)-th image frame by sequentially providing the emission signal to the emission lines in the second direction.

In example embodiments, the pixels coupled to the emission lines may sequentially emit light in the first direction when the (2k−1)-th image frame is displayed.

In example embodiments, the pixels coupled to the emission lines may sequentially emit light in the second direction when the (2k)-th image frame is displayed.

In example embodiments, the first direction may correspond to a direction from a top scan line to a bottom scan line, and the second direction may correspond to a direction from the bottom scan line to the top scan line.

In example embodiments, the first direction may correspond to a direction from a bottom scan line to a top scan line, and the second direction may correspond to a direction from the top scan line to the bottom scan line.

In example embodiments, the power voltage may be provided to a driving transistor in each of the pixels. The power voltage may have a first level in the initialization period and may have a second level greater than the first level in a period except the initialization period.

According to example embodiments, a method of driving an organic light emitting display device may include sequentially performing a scanning operation on a plurality of scan lines and an emitting operation on a plurality of emission lines in a first direction during a first period including j image frames, where j is a positive integer, and sequentially performing the scanning operation and the emitting operation in a second direction during a second period including the j image frames following the first period. The first and second periods may be alternately repeated to display a plurality of image frames.

In example embodiments, each of the image frames may include an initialization period to concurrently initialize a plurality of pixels.

In example embodiments, the first direction may correspond to a direction from a top scan line to a bottom scan line, and the second direction may correspond to a direction from the bottom scan line to the top scan line.

In example embodiments, the first direction may correspond to a direction from a bottom scan line to a top scan line, and the second direction may correspond to a direction from the top scan line to the bottom scan line.

According to example embodiments, an organic light emitting display device may include a display panel including a plurality of pixels, a scan driver configured to sequentially provide a scan signal to the pixels in a first direction or a second direction according to an image frame progress, an emission driver configured to sequentially provide an emission signal to the pixels in the first direction or the second direction to sequentially emit light in the first direction or the second direction, a data driver configured to provide a data signal to the pixels, a power supply configured to provide first and second power voltages to the pixels, and to change at least one of the first and second power voltages to concurrently initialize the pixels, and a timing controller configured to control the scan driver, the emission driver, the data driver, and the power supply.

In example embodiments, the first direction may correspond to a direction from a top scan line to a bottom scan line, and the second direction may correspond to a direction from the bottom scan line to the top scan line.

In example embodiments, the first direction may correspond to a direction from a bottom scan line to a top scan line, and the second direction may correspond to a direction from the top scan line to the bottom scan line.

In example embodiments, the scan driver may sequentially performs a scanning operation on a plurality of scan lines coupled to the pixels in the first direction to display a (2k−1)-th image frame, where k is a positive integer. The emission driver may sequentially provide the emission signal on a plurality of emission lines coupled to the pixels in the first direction to display the (2k−1)-th image frame.

In example embodiments, the scan driver may sequentially performs the scanning operation on the scan lines in the second direction to display a (2k)-th image frame. The emission driver may sequentially provide the emission signal on the emission lines in the second direction to display the (2k)-th image frame.

In example embodiments, the scan driver may change a scan direction that the scan signal is provided to a plurality of scan lines every j image frames, where j is a positive integer.

In example embodiments, the emission driver may change an emission direction that the emission signal is provided to a plurality of emission lines every the j image frames.

In example embodiments, the first power voltage may be provided to a driving transistor in each of the pixels and the second power voltage may be provided to a cathode of an organic light emitting diode in each of the pixels.

In example embodiments, the power supply may provide a low level of the first power voltage and a high level of the second power voltage to the pixels in an initialization period of the image frame to initialize the pixels.

In example embodiments, the power supply may change the first power voltage into the high level and second power voltage into the low level after the initialization period.

Therefore, the method of driving the organic light emitting display device according to example embodiments may perform an initializing operation and a compensating operation by a concurrent driving technique, such that sufficient time for initializing and compensating may be ensured. Further, the driving method may perform scanning and light emitting operations by a sequential driving technique for changing a direction of the scanning and light emitting operations after a set number (e.g., a predetermined number) of image frames, such that emission duties may be significantly improved compared to the typical concurrent emission driving technique. Thus, a driving current for luminance representation may decrease. Therefore, power consumption may decrease, and life of the pixels may increase.

In addition, the organic light emitting display device according to example embodiments may ensure a sufficient time for initializing and compensating, and may output an image having increased emission duties. Thus, the organic light emitting display device may display (i.e., may output) a high-quality image.

### BRIEF DESCRIPTION OF THE DRAWINGS

Example embodiments can be understood in more detail from the following description taken in conjunction with the accompanying drawings, in which:

FIG. 1 is a flow chart illustrating a method of driving an organic light emitting display device according to example embodiments.

FIG. 2 is a diagram illustrating an example of a driving method of FIG. 1.

FIG. 3 is a flow chart illustrating a method of driving an organic light emitting display device according to example embodiments.

FIG. 4A is a diagram illustrating an example of a driving method of FIG. 3.

FIG. 4B is a diagram illustrating an example of a driving method of FIG. 3.

FIG. 5 is a block diagram illustrating an organic light emitting display device according to example embodiments.

FIG. 6 is a diagram illustrating a frame operation period for displaying one image frame in an organic light emitting display device of FIG. 5.

FIG. 7 is a diagram illustrating a pixel included in an organic light emitting display device of FIG. 5.

FIG. 8 is a timing diagram illustrating signals provided for operating a pixel of FIG. 7.

FIG. 9A is a diagram illustrating an example in which a scan driver of an organic light emitting display device of FIG. 5 operates.

FIG. 9B is another diagram illustrating an example in which a scan driver of an organic light emitting display device of FIG. 5 operates.

FIG. 10A is a diagram illustrating an example in which an emission driver of an organic light emitting display device of FIG. 5 operates.

FIG. 10B is another diagram illustrating an example in which an emission driver of an organic light emitting display device of FIG. 5 operates

FIG. 11 is a block diagram illustrating an electronic device having an organic light emitting display device of FIG. 5.

### DETAILED DESCRIPTION

Exemplary embodiments will be described more fully hereinafter with reference to the accompanying drawings, in which various embodiments are shown.

It will be understood that, although the terms “first”, “second”, “third”, etc., may be used herein to describe various elements, components, regions, layers, and/or sections, these elements, components, regions, layers and/or sections should not be limited by these terms. These terms are used to distinguish one element, component, region, layer or section from another element, component, region, layer or section. Thus, a first element, component, region, layer, or section discussed below could be termed a second element, component, region, layer, or section, without departing from the spirit and scope of the present invention.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it will also be understood that when one element, component, region, layer and/or section is referred to as being “between” two elements, components, regions, layers, and/or sections, it can be the only element, component, region, layer and/or section between the two elements, components, regions, layers, and/or sections, or one or more intervening elements, components, regions, layers, and/or sections may also be present.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprise,” “comprises,” “comprising,” “includes,” “including,” and “include,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the present invention refers to “one or more embodiments of the present invention.” Also, the term “exemplary” is intended to refer to an example or illustration.

It will be understood that when an element or layer is referred to as being “on,” “connected to,” “coupled to,” “connected with,” “coupled with,” or “adjacent to” another element or layer, it can be “directly on,” “directly connected to,” “directly coupled to,” “directly connected with,” “directly coupled with,” or “directly adjacent to” the other element or layer, or one or more intervening elements or layers may be present. Further “connection,” “connected,” etc. may also refer to “electrical connection,” “electrically connect,” etc. depending on the context in which they are used as those skilled in the art would appreciate. When an element or layer is referred to as being “directly on,” “directly connected to,” “directly coupled to,” “directly connected with,” “directly coupled with,” or “immediately adjacent to” another element or layer, there are no intervening elements or layers present.

As used herein, the term “substantially,” “about,” and similar terms are used as terms of approximation and not as terms of degree, and are intended to account for the inherent deviations in measured or calculated values that would be recognized by those of ordinary skill in the art.

As used herein, the terms “use,” “using,” and “used” may be considered synonymous with the terms “utilize,” “utilizing,” and “utilized,” respectively.

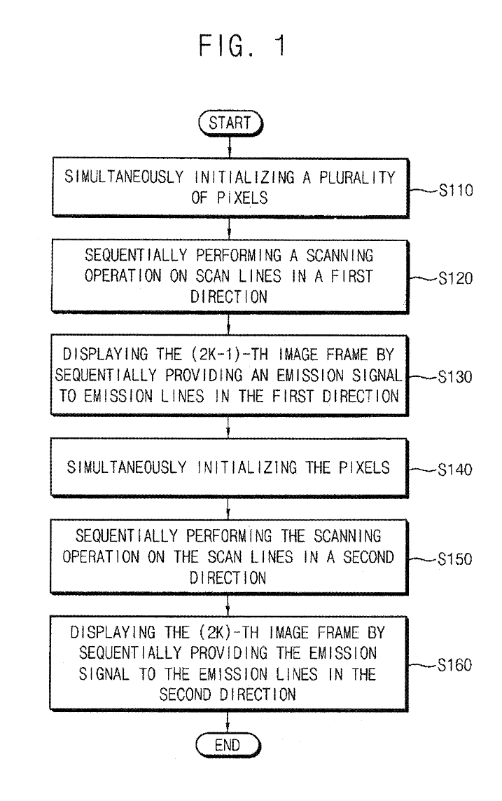

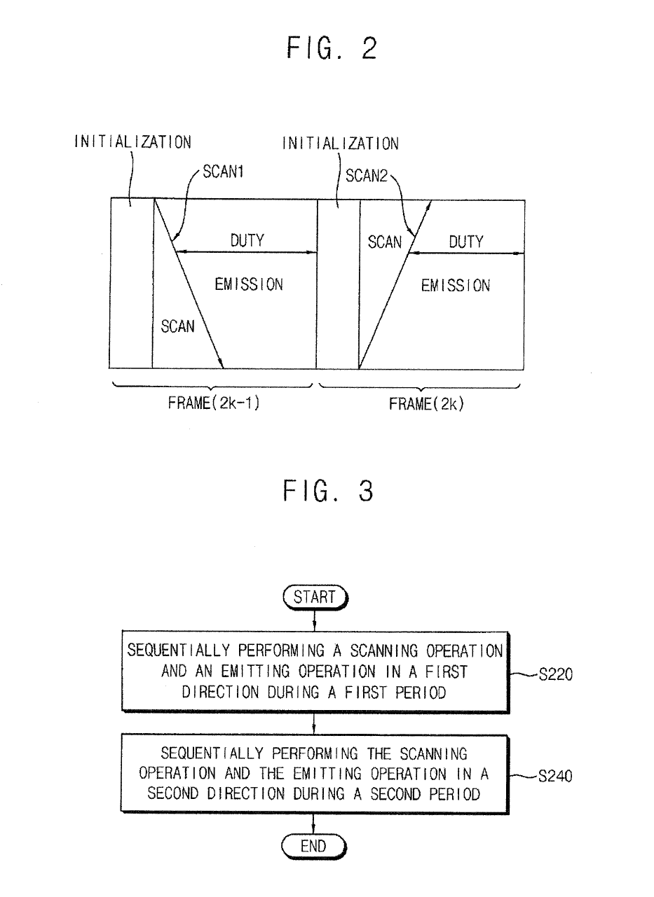

FIG. 1 is a flow chart illustrating a method of driving an organic light emitting display device according to example embodiments. FIG. 2 is a diagram illustrating an example of a driving method of FIG. 1.

Referring to FIGS. 1 and 2, the method of FIG. 1 may concurrently (e.g., simultaneously) initialize a plurality of pixels by adjusting a voltage level of a power voltage that is provided to the pixels during an initialization period of a (2k−1)-th image frame FRAME(2k−1) (k being a positive integer) S110, may sequentially write a first scan signal corresponding to the (2k−1)-th image frame FRAME(2k−1) into a plurality of scan lines by sequentially performing a scanning operation on the scan lines in a first direction (the scanning operation in the first direction being indicated as SCAN1 in FIG. 2) S120, and may display the (2k−1)-th image frame FRAME(2k−1) by sequentially providing an emission signal to a plurality of emission lines in the first direction S130.

Further, the method of FIG. 1 may concurrently initialize the pixels by adjusting the voltage level of the power voltage during an initialization period of (2k)-th image frame FRAME(2k) S140, may sequentially write a second scan signal corresponding to the (2k)-th image frame FRAME(2k) into the scan lines by sequentially performing the scanning operation on the scan lines in a second direction (the scanning operation in the second direction being indicated as SCAN2) S150, and may display the (2k)-th image frame FRAME(2k) by sequentially providing the emission signal to the emission lines in the second direction S160. Accordingly, the method of FIG. 1 may improve emission duty DUTY by changing a direction of the scanning operation between adjacent image frames FRAME(2k−1) and FRAME(2k).

As illustrated in FIG. 2, the organic light emitting display device may employ a combination of a concurrent driving technique (e.g., a simultaneous driving technique) and a sequential driving technique. Generally, a frame operation period for displaying one image frame FRAME(n) may include an initialization period for performing an initializing operation, a reset period for performing a resetting operation, a threshold voltage compensation period for performing a threshold voltage compensating operation, a scan period for performing a scanning operation, and an emission period for performing a light emitting operation. For convenience of description, only the initialization period INITIALIZATION, the scan period SCAN, and the emission period EMISSION are illustrated in FIG. 2. During the initialization period INITIALIZATION including the abovementioned reset period and the compensation period, the initializing operation, the resetting operation, and the compensating operation may be concurrently performed for all pixels. In contrast, during the scan period SCAN and the emission period EMISSION, the scanning operation and the light emitting operation may be sequentially performed for all pixels for each scan line (and/or each emission line). In other words, the initializing operation and the compensating operation may be performed by the concurrent driving technique, and a data writing operation (the scanning operation) and the light emitting operation may be performed by the sequential driving operation. Thus, sufficient time for initializing and compensating may be ensured by the concurrent driving technique.

However, an emission duty of the pixels coupled to lower scan lines (or upper scan lines) may be shorter than an emission duty of the pixels coupled to the upper scan lines (or the lower scan lines) when the scanning operation is sequentially performed in a direction from a top scan line to a bottom scan line, or in a direction from the bottom scan line to the top scan line. Thus, a difference between these emission duties may degrade luminance uniformity of a display panel included in the organic light emitting display device. To overcome these problems, the method of FIG. 1 may improve the luminance uniformity of the display panel by changing a direction of the scanning and light emitting operations every other image frame FRAME(n). Further, disadvantage of typical concurrent emission driving technique may be improved.

Specifically, the method of FIG. 1 may concurrently initialize the plurality of pixels by adjusting the voltage level of the power voltage that is provided to the pixels during the initialization periods INITIALIZATION of the image frames FRAME(2k−1) and FRAME(2k) S110 and S140. In some embodiments, the power voltage provided to a driving transistor included in each of the pixels may have a first level in the initialization period. The first level may be less than a level of a voltage applied to a second electrode of the driving transistor. Thus, a plurality of driving transistors respectively included the pixels may be concurrently initialized. The power voltage may have a second level that is greater than the first level during portions of the image frames FRAME(2k−1) and FRAME(2k) excluding the initialization period INITIALIZATION (e.g., during the scan period SCAN and the emission period EMISSION). For example, in the initialization period INITIALIZATION, a first power voltage applied to a first electrode of the driving transistor (e.g., a source electrode of a PMOS (P-channel metal oxide semiconductor) transistor) may be changed to a low level, and a second power voltage applied to a cathode of an organic light emitting diode may have a constant level. In some embodiments, in the initialization period INITIALIZATION, the first power voltage may have the low level, and the second power voltage may have a high level. Accordingly, at least one of the first and second power voltages may be adjusted to initialize the driving transistor, and to compensate the threshold voltage of the driving transistor. Here, the high level of the first power voltage and the second power voltage may be about 4V to about 5V, and the low level of the first power voltage and the second power voltage may be about −4V to about −5V. The second power voltage may maintain about −4V to about −5V, and the first power voltage may swing between the high and low levels.

The first data signal of the (2k−1)-th image frame FRAME(2k−1) may be sequentially written to the plurality of pixels by sequentially performing the scanning operation (indicated as SCAN1) on the scan lines in the first direction S120. The first data signal corresponds to the (2k−1)-th image frame FRAME(2k−1). Therefore, the first data signal indicates a data signal that is written to the pixels coupled to the scan lines.

Next, the method of FIG. 1 may display the (2k−1)-th image frame FRAME(2k−1) by sequentially providing the emission signal to the plurality of emission lines in the first direction S130. In some embodiments, the pixels (e.g., rows of pixels) may sequentially emit light in the first direction by sequentially providing the emission signal. Thus, as illustrated in FIG. 2, the emission duty DUTY may be different in one image frame FRAME(2k−1) than the emission duty DUTY in another image frame FRAME(2k). For example, the emission duty DUTY of the (2k−1)-th image frame FRAME(2k−1) may decrease from the top scan line toward the bottom scan line. In contrast, the emission duty of the (2k)-th image frame FRAME(2k) may decrease from the bottom scan line toward the top scan line. Accordingly, the difference of the emission may occur in the (2k−1)-th image frame FRAME(2k−1) when compared to the (2k)-th image frame FRAME(2k). The scanning and light emitting operations of the following image frame (e.g., the (2k)-th image frame FRAME(2k)) may be performed in the second direction to offset the difference of the emission duties DUTY otherwise occurring between the two image frames FRAME(2k−1) and FRAME(2k).

Specifically, the method of FIG. 1 may concurrently initialize the pixels S140, and may sequentially write the second data signal constituting the (2k)-th image frame FRAME(2k) into the plurality of pixels by sequentially performing the scanning operation on the scan lines in the second direction (indicated as SCAN2) S150. Here, the second data signal corresponds to the (2k)-th image frame FRAME(2k). Therefore, the second data signal indicates a data signal that is written into the pixels coupled to the scan lines.

Next, the method of FIG. 1 may display the (2k)-th image frame FRAME(2k) by sequentially providing the emission signal to the plurality of emission lines in the second direction S160. In some embodiments, the pixels (e.g., rows of pixels) may sequentially emit light in the second direction by sequentially providing the emission signal. In the present embodiment, the first direction may be opposite to the second direction. In one embodiment, the first direction may correspond to a direction from the top scan line to the bottom scan line, and the second direction may correspond to a direction from the bottom scan line to the top scan line. In another embodiment, the first direction may correspond to a direction from the bottom scan line to the top scan line, and the second direction may correspond to a direction from the top scan line to the bottom scan line. FIG. 2 illustrates that the first direction corresponds to a direction from the top scan line to the bottom scan line (indicated as SCAN1), and the second direction corresponds to a direction from the bottom scan line to the top scan line (indicated as SCAN2).

As described above, the driving method of FIG. 1 may perform the initializing and compensating operations by the concurrent driving technique such that sufficient time for initializing and compensating may be ensured. In addition, the driving method of FIG. 1 may alternately perform the scanning (i.e., the data writing) and light emitting operations by the sequential driving technique in the first and second directions for each image frame FRAME(2k−1) and FRAME(2k), such that the emission duty may be significantly improved compared to the typical concurrent emission driving technique. Thus, a driving current for luminance representation may decrease. Therefore, power consumption may decrease, and lifespan of the pixels may increase.

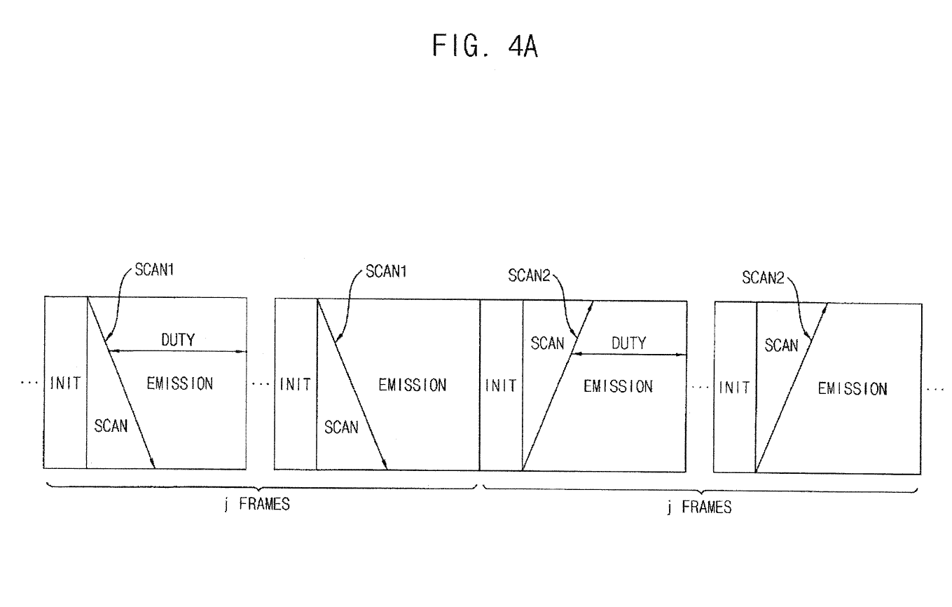

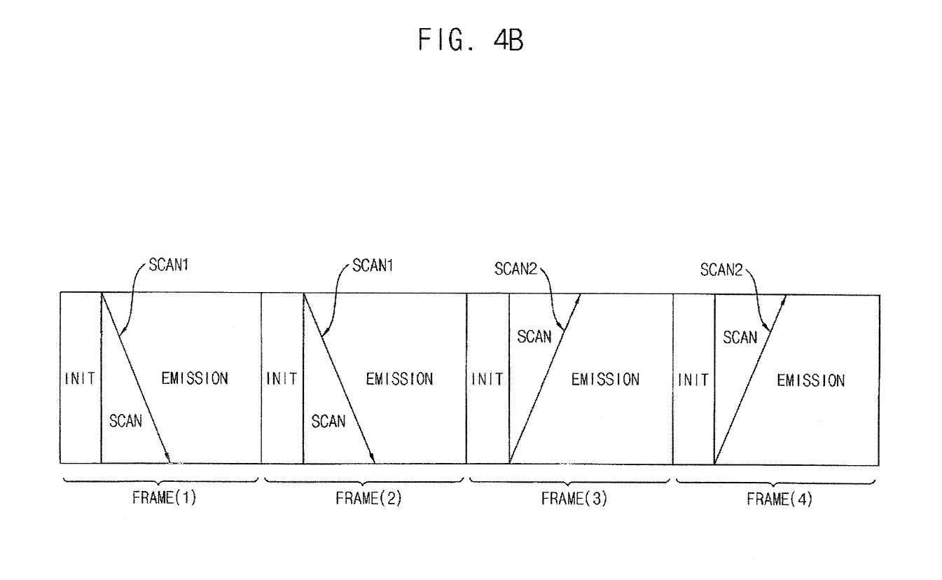

FIG. 3 is a flow chart illustrating a method of driving an organic light emitting display device according to example embodiments. FIG. 4A is a diagram illustrating an example of a driving method of FIG. 3.

Referring to FIGS. 3 and 4A, the method of FIG. 3 may sequentially perform a scanning operation on a plurality of scan lines (the scanning operation being indicated as SCAN1) and a light emitting operation on a plurality of emission lines in a first direction during a first period including j image frames “j FRAMES” S220 (j being a positive integer), and sequentially perform the scanning operation and the light emitting operation in a second direction during a second period including the j image frames “j FRAMES” following the first period S240. The method of FIG. 3 may alternately repeat the first and second periods to display a plurality of image frames. Accordingly, the method of FIG. 3 may change the scanning and emitting directions every j frames so that the emission duty may be ensured.

For convenience of description, only an initialization period INIT, a scan period SCAN, and an emission period EMISSION are illustrated in FIG. 4A. In some embodiments, the initialization period INIT may include the reset period and the compensation period.

Specifically, the method of FIG. 3 may sequentially perform the scanning operation on the scan lines and the light emitting operation on the emission lines in a first direction during a first period including j image frames “j FRAMES” S220 (the scanning operation in the first direction being indicated as SCAN1). Each of the image frames may include the initialization period INIT to concurrently initialize the pixels. In other words, the initializing operation may be performed by the concurrent driving technique, and the scanning operation and the light emitting operation may be performed by the sequential driving operation. A data signal may be sequentially written to the pixels in the first direction by the scanning operation SCAN1 at each of the image frames. The pixels may sequentially emit light in the first direction by the light emitting operation at each of the image frames.

Next, the method of FIG. 3 may sequentially perform the scanning operation and the light emitting operation in the second direction (the scanning operation in the second direction being indicated as SCAN2) during the second period including j image frames “j FRAMES” following the first period S240 (the first period including a different set of j image frames “j FRAMES” from those of the second period). Each of the image frames may include the initialization period INIT to concurrently initialize the pixels. A data signal may be sequentially written to the pixels in the second direction by the scanning operation SCAN2 at each of the image frames. The pixels may sequentially emit light in the second direction by the light emitting operation at each of the image frames. Accordingly, the method of FIG. 3 may change scan and emission direction in the opposite direction every j frames.

The first direction may be opposite to the second direction. In one embodiment, the first direction may correspond to a direction from the top scan line to the bottom scan line, and the second direction may correspond to a direction from the bottom scan line to the top scan line. In another embodiment, the first direction may correspond to a direction from the bottom scan line to the top scan line, and the second direction may correspond to a direction from the top scan line to the bottom scan line. It is illustrated in FIG. 4A that the first direction corresponds to a direction from the top scan line to the bottom scan line (the first direction corresponding to the scanning operation SCAN1), and the second direction corresponds to a direction from the bottom scan line to the top scan line (the second direction corresponding to the scanning operation SCAN2).

As described above, the method of FIG. 3 may perform the initializing and compensating operations by the concurrent driving technique such that sufficient time for initializing and compensating may be ensured. In addition, the driving method of FIG. 3 may alternately perform the scanning (i.e., the data writing) and light emitting operations by the sequential driving technique in the first and second directions every j image frames, such that the emission duty may be significantly improved compared to the typical concurrent emission driving technique. Thus, a driving current for luminance representation may decrease. Therefore, power consumption may decrease, and lifespan of the pixels may increase.

FIG. 4B is a diagram illustrating an example of a driving method of FIG. 3.

Referring to FIG. 4B, a method of driving an organic light emitting display device may change a scanning and emitting direction every two image frames (e.g., the scanning and emitting direction may be changed every other set of two image frames).

For example, as illustrated in FIG. 4B, the scanning and light emitting operations may be sequentially performed in a first direction during first and second image frames FRAME(1) and FRAME(2). The scanning and light emitting operations may be sequentially performed in a second direction during third and fourth image frames FRAME(3) and FRAME(4). The scanning and emitting direction may change every two image frames.

In one embodiment, the first direction may correspond to a direction from the top scan line to the bottom scan line, and the second direction may correspond to a direction from the bottom scan line to the top scan line. In another embodiment, the first direction may correspond to a direction from the bottom scan line to the top scan line, and the second direction may correspond to a direction from the top scan line to the bottom scan line.

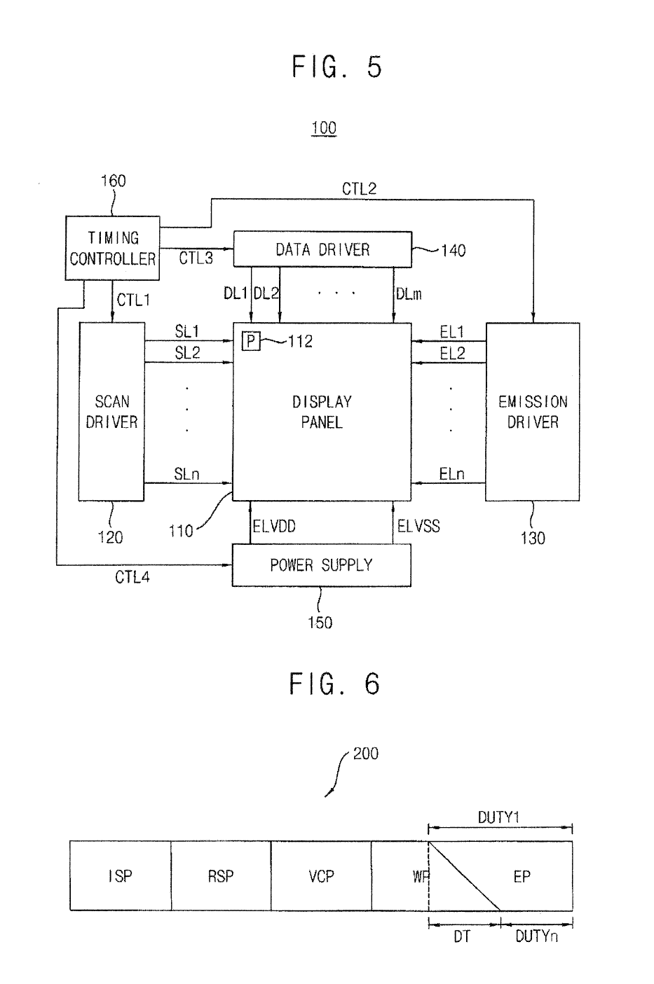

FIG. 5 is a block diagram illustrating an organic light emitting display device according to example embodiments. FIG. 6 is a diagram illustrating a frame operation period for displaying one image frame in an organic light emitting display device of FIG. 5.

Referring to FIGS. 5 and 6, the organic light emitting display device 100 may include a display panel 110, a scan driver 120, an emission driver 130, a data driver 140, a power supply 150, and a timing controller 160.

The display panel 110 may include a plurality of pixels 112. Specifically, the pixels 112 may be arranged at locations corresponding to respective crossing points of a plurality of scan lines SL1 through SLn and a plurality of data lines DL1 through DLm. In the display panel 110, the scan lines SL1 through SLn that transmit a scan signal may be formed in a first arrangement direction (e.g., an X-axis direction in FIG. 5), a plurality of emission lines EL1 through ELn that transmit an emission signal may be formed in the first arrangement direction, the data lines DL1 through DLm that transmit a data signal may be formed in a second arrangement direction (e.g., a Y-axis direction in FIG. 5), and a plurality of power lines that transmit a high power voltage ELVDD and a low power voltage ELVSS may be formed in the first arrangement direction or in the second arrangement direction.

The scan driver 120 may sequentially provide the scan signal to the pixels 112 of the display panel 110 via the scan-lines SL1 through SLn. The scan driver 120 may sequentially provide the scan signal to the pixels 112 in a first direction or in a second direction according to an image frame progress. Generally, as illustrated in FIG. 6, a frame operation period 200 for displaying one image frame may include an initialization period ISP for performing an initializing operation, a reset period RSP for performing a resetting operation, a threshold voltage compensation period VCP for performing a threshold voltage compensating operation, a scan period WP for performing a scanning operation, and an emission period EP for performing a light emitting operation. Here, each of the initializing operation, the resetting operation, and the threshold voltage compensating operation may be concurrently performed for all pixels 112, whereas the scanning operation may be sequentially performed for all pixels 112 for each scan line (e.g., in order of SL1 through SLn) and the light emitting operation may be sequentially performed for all pixels 112 for each emission line (e.g., in order of ELI through ELn). As a result, an emission duty may gradually increase or decrease in order of emission lines ELI through ELn in the one image frame during the frame operation period 200. Thus, a difference DT between an emission duty DUTY1 of the first emission line ELI on which the first light emitting operation is performed and an emission duty DUTYn of the n-th emission line ELn on which the last light emitting operation is performed may occur in the emission period EP. Thus, in the organic light emitting display device 100, the scan driver 120 and the emission driver 130 may change a direction of the scanning and light emitting operations between adjacent image frames, so that sufficient emission duties may be ensured. As a result, the luminance uniformity of the display panel 110 included in the organic light emitting display device 100 may be improved, and power consumption for light emission may be decreased.

In some embodiments, the scan driver 120 may sequentially perform the scanning operation on the scan lines SL1 through SLn coupled to the pixels 112 in the first direction to display a (2k−1)-th image frame, where k is a positive integer. The scan driver 120 may sequentially perform the scanning operation on the scan lines SL1 through SLn in the second direction to display a (2k)-th image frame. In the present embodiment, the first direction may correspond to a direction from a top scan line (e.g., SL1) to a bottom scan line (e.g., SLn), and the second direction may correspond to a direction from the bottom scan line to the top scan line. In another embodiment, the first direction may correspond to a direction from the bottom scan line to the top scan line, and the second direction may correspond to a direction from the top scan line to the bottom scan line. Because these are described above, duplicated descriptions will not be repeated.

In one embodiment, the scan driver 120 may change a scan direction in which the scan signal is provided to the scan lines SL1 through SLn every j image frames, where j is a positive integer. For example, the scan driver 120 may perform the scanning operation in the first direction during a set of first j image frames, and perform the scanning operation in the second direction during a set of second j image frames following the set of first j image frames.

The emission driver 130 may sequentially provide the emission signal to the pixels 112 in the first direction or in the second direction to sequentially emit light in the first direction or in the second direction according to the image frame progress. In one embodiment, the emission driver 130 may sequentially provide the emission signal on the emission lines EL1 through ELn in the first direction according to the operation of the scan driver 120 to display the (2k−1)-th image frame. The emission driver 130 may sequentially provide the emission signal on the emission lines EL1 through ELn in the second direction to display the (2k)-th image frame. In some embodiments, the emission signal may disconnect a driving transistor included in each of the pixels 112 from the power voltage so that light emission may be blocked.

In some embodiments, the emission driver 130 may change an emission direction in which the emission signal is provided to the emission lines EL1 through ELn every j image frames according to the operation of the scan driver 120. For example, the emission driver 130 may perform the light emitting operation in the first direction during the first set of j image frames, and may perform the light emitting operation in the second direction during the second set of j image frames following the first j image frames.

The data driver 140 may provide a data signal to the pixels 112 included in the display panel 110 via the data lines DL1 through DLm.

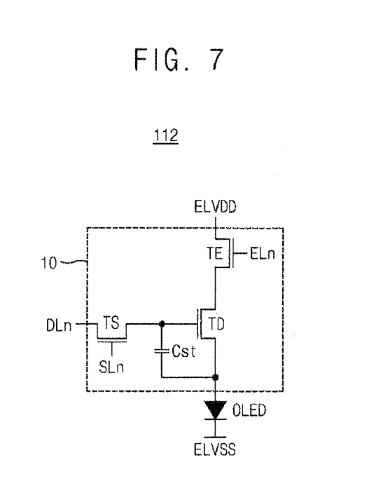

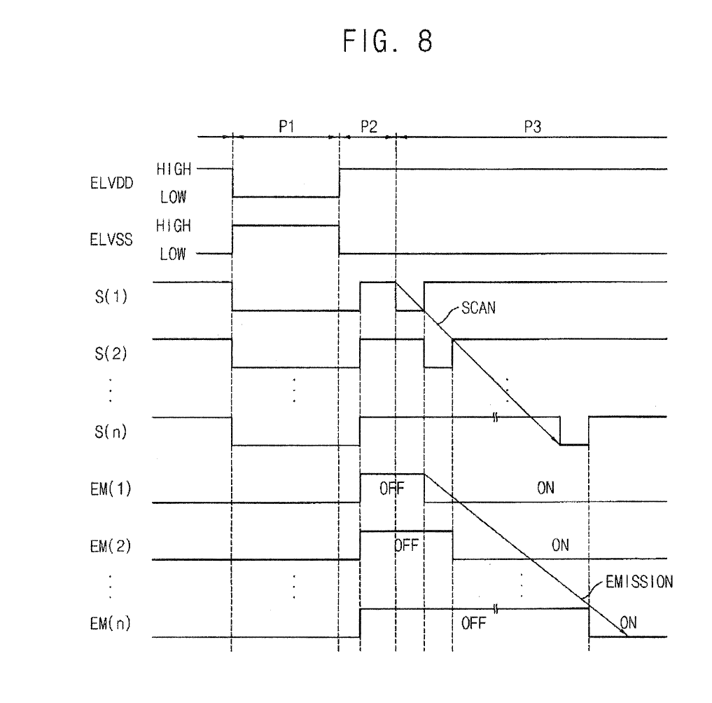

The power supply 150 may provide first and second power voltages ELVDD and ELVSS to the pixels 112. The power supply 150 may change at least one of the first and second power voltages ELVDD and ELVSS to concurrently initialize the pixels 112. In one embodiment, the power supply 150 may provide a low level of the first power voltage ELVDD and a high level of the second power voltage to the pixels 112 in an initialization period of the image frame to initialize the pixels 112. The power supply 150 may change the first power voltage ELVDD into the high level and second power voltage into the low level after the initialization period. The initializing operation will be described in detail with reference to FIGS. 7 and 8.

The timing controller 160 may generate first to fourth control signals CTL1, CTL2, CTL3, and CTL4, and may provide the first to fourth control signals CTL1, CTL2, CTL3, and CTL4 to the scan driver 120, the emission driver 130, the data driver 140, and the power supply 150 so as to control the scan driver 120, the emission driver 130, the data driver 140, and the power supply 150.

Accordingly, the organic light emitting display device 100 may perform the scanning and light emitting operations by the concurrent driving technique, and change the scan and emission direction in the opposite directions every set number (e.g., predetermined number) of image frames, so that the emission duty may be significantly improved compared to the typical concurrent emission driving technique. In addition, the organic light emitting display device 100 may perform the initializing and compensating operations by the concurrent driving technique so that sufficient time for initializing and compensating may be ensured.

FIG. 7 is a diagram illustrating a pixel included in an organic light emitting display device of FIG. 5. FIG. 8 is a timing diagram illustrating signals provided for operating a pixel of FIG. 7.

Referring to FIGS. 7 and 8, the pixel 112 may include an organic light emitting diode OLED and a pixel circuit 10 to provide a driving current to the organic light emitting diode OLED. The pixel circuit 10 may include a driving transistor TD, a switching transistor TS, and an emission control transistor TE. The organic light emitting diode OLED may emit light based on the signals of FIG. 8.

An anode of the organic light emitting diode OLED may be coupled to the pixel circuit 10, and a cathode of the organic light emitting diode OLED may be coupled to a second power voltage ELVSS. The organic light emitting diode OLED may generate light having a specific luminance corresponding to the driving current from the pixel circuit 10.

The switching transistor TS may include a gate electrode coupled to a scan line SLn, a first electrode coupled to a data line DLn, and a second electrode coupled to a gate electrode of the driving transistor TD. A scan signal may be provided to the gate electrode of the switching transistor TS, and a data signal may be provided to the first electrode of the switching transistor TS.

The driving transistor TD may include the gate electrode coupled to the second electrode of the switching transistor TS, a first electrode coupled to a second electrode of the emission control transistor TE, and a second electrode coupled to the anode of the organic light emitting diode OLED.

The emission control transistor TE may include a gate electrode coupled to an emission line ELn, a first electrode coupled to a first power voltage ELVDD, and the second electrode coupled to the first electrode of the driving transistor TD. The emission control transistor TE may control an emission period of the organic light emitting diode OLED based on an emission signal.

The pixel circuit 10 may further include a storage capacitor Cst coupled between the gate electrode of the driving transistor TD and the second electrode of the gate electrode.

In one embodiment, the transistors in the pixel circuit 10 may be PMOS transistor. Because this is an example, the transistors are not limited thereto. For example, the transistors may be NMOS (N-channel metal oxide semiconductor) transistors.

As illustrated in FIG. 8, the pixel 112 may perform an initializing operation and a threshold voltage compensating operation by a concurrent driving technique, and may perform a scanning operation and a light emitting operation by a sequential driving technique.

Each image frame may include an initialization period P1, a threshold voltage compensation period P2, and a scan and emission period P3.

Here, scan signals S(1) through S(n) and emission signals EM(1) through EM(n) may be sequentially provided to respective scan lines and emission lines in the scan and emission period P3. In contrast, the scan signals S(1) through S(n) and emission signals EM(1) through EM(n) having substantially the same voltage level may be concurrently provided to all pixels in the initialization period P1 and the threshold voltage compensation period P2. Thus, initializing the driving transistor TD may be concurrently performed on all pixels and compensating the threshold voltage of the driving transistor TD may be concurrently performed on all pixels. Hereafter, the operation of the pixels 112 will be explained with the pixels 112 including PMOS transistors.

In one embodiment, the first and second power voltages ELVDD and ELVSS may have two voltage levels, i.e., a high level and a low level. For example, the high level may be about 4V to about 5V, and the low level may be about −4V to about −5V.

A gate voltage of the driving transistor TD may be initialized in the initialization period P1. In one embodiment, the scan signals S(1) through S(n) and emission signals EM(1) through EM(n) having a logic low level may be provided to all the pixels during the initialization period P1. The first power voltage ELVDD having the low level and the second power voltage ELVSS having the high level may be provided to all the pixels during the initialization period P1. Thus, the gate voltage of the driving transistors TD may be concurrently initialized.

The first power voltage ELVDD may change into the high level and the second power voltage ELVSS may change into the low level in the threshold voltage compensation period P2. Here, a reference voltage for compensating the threshold voltage of the driving transistor TD may be provided to the gate electrode of the driving transistor TD via the data line DLn. The reference voltage may be less than a logic high level of the scan signals S(1) through S(n). The scan signals S(1) through S(n) and the emission signals EM(1) through EM(n) may concurrently change into the logic high level in the threshold voltage compensation period P2.

The scan signals S(1) through S(n) may be sequentially provided to the scan lines in the scan and emission period P3. Thus, data signals constituting a specific image frame may be sequentially written at the pixels coupled to the scan lines. In one embodiment, a scan direction may correspond to a first direction or a second direction opposite to the first direction. The first direction may correspond to a direction from a top scan line to a bottom scan line, and the second direction corresponds to a direction from the bottom scan line to the top scan line. The emission signals EM(1) through EM(n) may be also sequentially provided to the emission lines in the scan and emission period P3. Thus, the pixels may sequentially emit light in the first direction or the second direction according to the scan lines.

Accordingly, the organic light emitting display device 100 performing sequential emitting operation may concurrently perform initializing (including pixel resetting) and compensating operations on all pixels, so that sufficient time for initializing and compensating may be ensured. Thus, the organic light emitting display device 100 may display a high quality image.

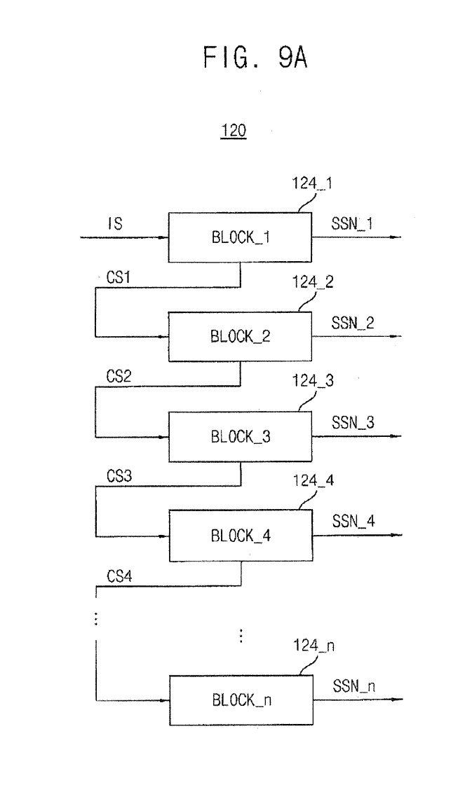

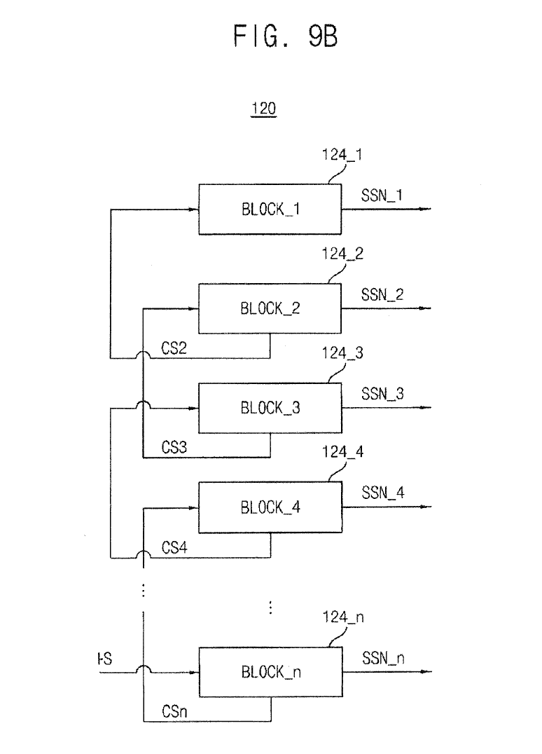

FIGS. 9A and 9B are diagrams illustrating an example in which a scan driver of an organic light emitting display device of FIG. 5 operates.

Referring to FIGS. 5, 9A and 9B, a scan driver 120 of the organic light emitting display device 100 may include first through (n)-th output blocks 124_1 through 124_n. Here, the first through (n)-th output blocks 124_1 through 124_n may output first through (n)-th scan signals SSN_1 through SSN_n, respectively.

As illustrated in FIG. 9A, the scan driver 120 may sequentially perform a scanning operation on scan lines SL1 through SLn in a first direction (e.g., a direction from the top scan line to the bottom scan line) during a (2k−1)-th image frame. Specifically, when the scan driver 120 performs the scanning operation on the scan lines SL1 through SLn, the first output block 124_1 may output the first scan signal SSN_1 in response to an initial control signal IS, then the second output block 124_2 may output the second scan signal SSN_2 in response to a sequential control signal CS1 outputted from the first output block 124_1, and then the third output block 124_3 may output the third scan signal SSN_3 in response to a sequential control signal CS2 outputted from the second output block 124_2. In this way, the scan driver 120 may perform the scanning operation on the scan lines in the first direction.

As illustrated in FIG. 9B, the scan driver 120 may sequentially perform the scanning operation on scan lines SL1 through SLn in a second direction (e.g., a direction from the bottom scan line to the top scan line) during a (2k)-th image frame. Specifically, when the scan driver 120 performs the scanning operation on the scan lines SL1 through SLn, the (n)-th output block 124_n may output the (n)-th scan signal SSN_n in response to an initial control signal IS, the fourth output block 124_4 may output the fourth scan signal SSN_4 in response to a sequential control signal CSn outputted from the (n)-th output block 124_m, the third output block 124_3 may output the third scan signal SSN_3 in response to a sequential control signal CS4 outputted from the fourth output block 124_4, and then the second output block 124_2 may output the second scan signal SSN_2 in response to a sequential control signal CS3 outputted from the third output block 124_3. In this way, the scan driver 120 may perform the scanning operation on scan lines SLi through SLn in the second direction (e.g., a direction from the bottom scan line to the top scan line). Because the structure and the operation of the scan driver 120 illustrated in FIGS. 9A and 9B is exemplary, the structure and the operation of the scan driver 120 is not limited thereto.

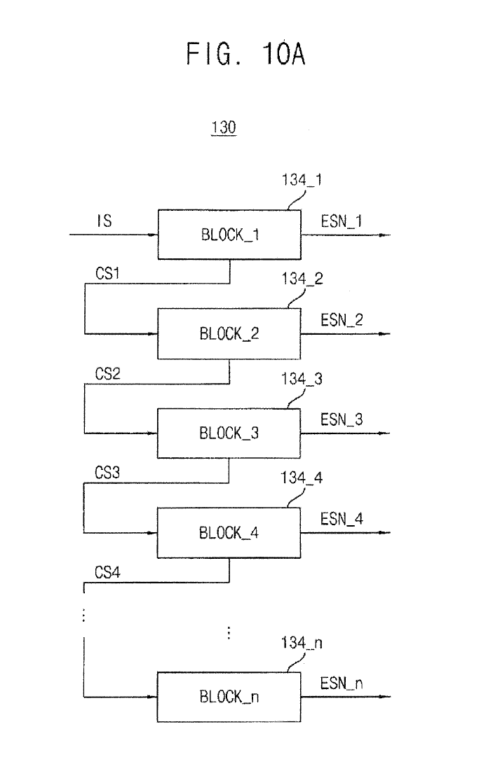

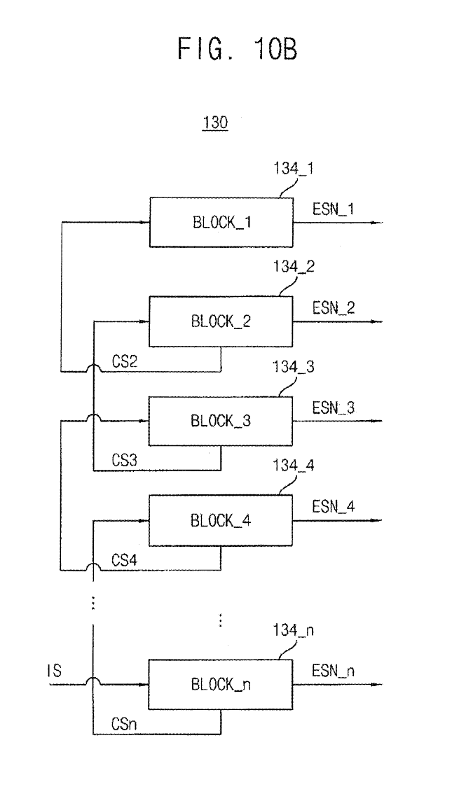

FIGS. 10A and 10B are diagrams illustrating an example in which an emission driver of an organic light emitting display device of FIG. 5 operates.

Referring to FIGS. 5, 10A and 10B, an emission driver 130 of the organic light emitting display device 100 may include first through (n)-th output blocks 134_1 through 134_n. Here, the first through (n)-th output blocks 134_1 through 134_n may output first through (n)-th emission signals ESN_1 through ESN_n, respectively.

As illustrated in FIG. 10A, the emission driver 130 may sequentially perform a light emitting operation on emission lines EL1 through ELn in a first direction (e.g., a direction from the top emission line to the bottom emission line) during the (2k−1)-th image frame. Specifically, when the emission driver 130 performs the light emitting operation on the emission lines EL1 through ELn, the first output block 134_1 may output the first emission signal ESN_1 in response to an initial control signal IS, then the second output block 134_2 may output the second emission signal ESN_2 in response to a sequential control signal CS1 outputted from the first output block 134_1, and then the third output block 134_3 may output the third emission signal ESN_3 in response to a sequential control signal CS2 outputted from the second output block 134_2. In this way, the emission driver 130 may perform the light emitting operation on the emission lines in the first direction.

As illustrated in FIG. 10B, the emission driver 130 may sequentially perform the light emitting operation on emission lines EL1 through ELn in a second direction (e.g., a direction from the bottom emission line to the top emission line) during the (2k)-th image frame. Specifically, when the emission driver 130 performs the light emitting operation on the emission lines ELI through ELn, the (n)-th output block 134_n may output the (n)-th emission signal ESN_n in response to an initial control signal IS, the fourth output block 134_4 may output the fourth emission signal ESN_4 in response to a sequential control signal CSn outputted from the (n)-th output block 134_m, the third output block 134_3 may output the third emission signal ESN_3 in response to a sequential control signal CS4 outputted from the fourth output block 134_4, and then the second output block 134_2 may output the second emission signal ESN_2 in response to a sequential control signal CS3 outputted from the third output block 1343. In this way, the emission driver 130 may perform the light emitting operation on emission lines EL1 through ELn in the second direction (e.g., a direction from the bottom emission line to the top emission line). Because the structure and the operation of the emission driver 130 illustrated in FIGS. 10A and 10B is exemplary, the structure and the operation of the emission driver 130 is not limited thereto.

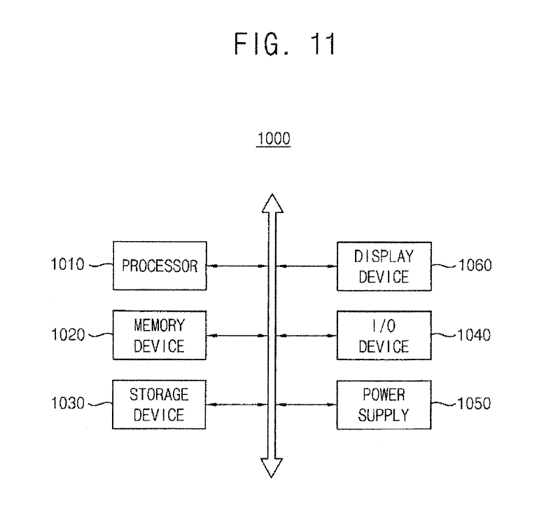

FIG. 11 is a block diagram illustrating an electronic device having an organic light emitting display device of FIG. 5.

Referring to FIG. 11, the electronic device 1000 may include a processor 1010, a memory device 1020, a storage device 1030, an input/output (I/O) device 1040, a power supply 1050, and an organic light emitting display device 1060. Here, the organic light emitting display device 1060 may correspond to the organic tight emitting display device 100 of FIG. 5. In addition, the electronic device 1000 may further include a plurality of ports for communicating with a video card, a sound card, a memory card, a universal serial bus (USB) device, other suitable electronic devices, etc.

The processor 1010 may perform various suitable computing functions. The processor 1010 may be a microprocessor, a central processing unit (CPU), etc. The processor 1010 may be coupled to other suitable components via an address bus, a control bus, a data bus, etc. Furthermore, the processor 1010 may be coupled to an extended bus such as a peripheral component interconnection (PCI) bus.

The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc., and/or at least one volatile memory device such as a dynamic random access memory (DRAM) device, a static random access memory (SRAM) device, a mobile DRAM device, etc. The storage device 1030 may also store data for operations of the electronic device 1000. The storage device 1030 may be a solid state drive (SSD) device, a hard disk drive (HDD) device, a CD-ROM device, etc.

The I/O device 1040 may be an input device such as a keyboard, a keypad, a touchpad, a touch-screen, a mouse, etc., and an output device such as a printer, a speaker, etc. According to some exemplary embodiments, the organic light emitting display device 1060 may be included in the I/O device 1040.

The power supply 1050 may provide power for operation of the electronic device 1000. The organic light emitting display device 1060 may communicate with other suitable components via the buses or other suitable communication links.

As described above, the organic light emitting display device 1060 may employ a concurrent driving technique in an initializing operation and a threshold voltage compensating operation and may employ a sequential driving technique in a scanning operation and a light emitting operation. The organic light emitting display device 1060 may include a display panel having a plurality of pixels, a scan driver that provides a scan signal to the pixels, an emission driver that provides an emission signal to the pixels, a data driver that provides a data signal to the pixels, a power supply that provides a high power voltage and a low power voltage to the pixels, a timing controller that controls the scan driver, the emission driver, the data driver, and the timing controller. Here, the scan driver and the emission driver may increase emission duties by changing a direction of the scanning and light emitting operations every set number (e.g., predetermined number) of image frames. Further, the organic light emitting display device 1060 may concurrently perform the initializing and compensating operations by the concurrent driving technique so as to sufficient time for initializing and compensating may be ensured. Therefore, the luminance uniformity of the display panel included in the organic light emitting display device 1060 may be improved. As a result, a driving current for luminance representation may decrease and power consumption may decrease. The luminance uniformity of the display panel included in the organic light emitting display device 1060 may be also improved such that the organic light emitting display device 1060 may display (i.e., may output) a high-quality image.

The present embodiments may be applied to any display device and any system including the display device. For example, the present embodiments may be applied to a television, a computer monitor, a laptop, a digital camera, a cellular phone, a smart phone, a smart pad, a personal digital assistant (PDA), a portable multimedia player (PMP), a MP3 player, a navigation system, a game console, a video phone, etc.

The foregoing is illustrative of example embodiments, and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A method of driving an organic light emitting display device, comprising:
concurrently initializing a plurality of pixels by adjusting a voltage level of a power voltage which is provided to the pixels during an initialization period of a (2k−1)-th image frame, where k is a positive integer;
sequentially writing a first data signal comprising the (2k−1)-th image frame into the plurality of pixels by sequentially performing a scanning operation on a plurality of scan lines in a first direction;
displaying the (2k−1)-th image frame by sequentially providing an emission signal to a plurality of emission lines in the first direction;
concurrently initializing the pixels by adjusting the voltage level of the power voltage during an initialization period of a (2k)-th image frame;
sequentially writing a second data signal comprising the (2k)-th image frame into the plurality of pixels by sequentially performing the scanning operation on the plurality of scan lines in a second direction; and
displaying the (2k)-th image frame by sequentially providing the emission signal to the emission lines in the second direction.

2. The method of claim 1,
wherein the pixels coupled to the emission lines sequentially emit light in the first direction when the (2k−1)-th image frame is displayed.

3. The method of claim 1,
wherein the pixels coupled to the emission lines sequentially emit light in the second direction when the (2k)-th image frame is displayed.

4. The method of claim 1,
wherein the first direction corresponds to a direction from a top scan line to a bottom scan line, and
wherein the second direction corresponds to a direction from the bottom scan line to the top scan line.

5. The method of claim 1,
wherein the first direction corresponds to a direction from a bottom scan line to a top scan line, and
wherein the second direction corresponds to a direction from the top scan line to the bottom scan line.

6. The method of claim 1,
wherein the power voltage is provided to a driving transistor in each of the pixels, and
wherein the power voltage has a first level in the initialization period and has a second level greater than the first level in a period except the initialization period.

7. A method for driving an organic light emitting display device, comprising:
sequentially performing a scanning operation on a plurality of scan lines and an emitting operation on a plurality of emission lines in a first direction during a first period comprising j image frames, where j is a positive integer; and
sequentially performing the scanning operation and the emitting operation in a second direction during a second period comprising the j image frames following the first period,
wherein the first and second periods are alternately repeated to display a plurality of image frames.

8. The method of claim 7,
wherein each of the image frames comprises an initialization period to concurrently initialize a plurality of pixels.

9. The method of claim 7,
wherein the first direction corresponds to a direction from a top scan line to a bottom scan line, and
wherein the second direction corresponds to a direction from the bottom scan line to the top scan line.

10. The method of claim 7,
wherein the first direction corresponds to a direction from a bottom scan line to a top scan line, and
wherein the second direction corresponds to a direction from the top scan line to the bottom scan line.

11. An organic light emitting display device, comprising:
a display panel comprising a plurality of pixels;
a scan driver configured to sequentially provide a scan signal to the pixels in a first direction or a second direction according to an image frame progress;
an emission driver configured to sequentially provide an emission signal to the pixels in the first direction or the second direction to sequentially emit light in the first direction or the second direction;
a data driver configured to provide a data signal to the pixels;
a power supply configured to provide first and second power voltages to the pixels, and to change at least one of the first and second power voltages to concurrently initialize the pixels; and
a timing controller configured to control the scan driver, the emission driver, the data driver, and the power supply.

12. The display device of claim 11,
wherein the first direction corresponds to a direction from a top scan line to a bottom scan line, and
wherein the second direction corresponds to a direction from the bottom scan line to the top scan line.

13. The display device of claim 11,
wherein the first direction corresponds to a direction from a bottom scan line to a top scan line, and
wherein the second direction corresponds to a direction from the top scan line to the bottom scan line.

14. The display device of claim 11,
wherein the scan driver is configured to sequentially perform a scanning operation on a plurality of scan lines coupled to the pixels in the first direction to display a (2k−1)-th image frame, where k is a positive integer, and
wherein the emission driver is configured to sequentially provide the emission signal on a plurality of emission lines coupled to the pixels in the first direction to display the (2k−1)-th image frame.

15. The display device of claim 14,
wherein the scan driver is configured to sequentially perform the scanning operation on the scan lines in the second direction to display a (2k)-th image frame, and
wherein the emission driver is configured to sequentially provide the emission signal on the emission lines in the second direction to display the (2k)-th image frame.

16. The display device of claim 11,
wherein the scan driver is configured to change a scan direction that the scan signal is provided to a plurality of scan lines every j image frames, where j is a positive integer.

17. The display device of claim 16,
wherein the emission driver is configured to change an emission direction that the emission signal is provided to a plurality of emission lines every the j image frames.

18. The display device of claim 11,
wherein the first power voltage is configured to be provided to a driving transistor in each of the pixels and
wherein the second power voltage is configured to be provided to a cathode of an organic light emitting diode in each of the pixels.

19. The display device of claim 11,
wherein the power supply is configured to provide a low level of the first power voltage and a high level of the second power voltage to the pixels in an initialization period of the image frame to initialize the pixels.

20. The display device of claim 19,
wherein the power supply is configured to change the first power voltage into the high level and second power voltage into the low level after the initialization period.
